(19) United States
(12) Patent Application Publication
(10) Pub. No.: US 2024/0326719 A1
(43) Pub. Date: Oct. 3, 2024

(54) REFLECTION BLOCKING SYSTEM

(71) Applicants: Sherry Fessler, Emery, SD (US); Lisa Corliss, Emery, SD (US)

(72) Inventors: Sherry Fessler, Emery, SD (US); Lisa Corliss, Emery, SD (US)

(21) Appl. No.: 18/128,604

(22) Filed: Mar. 30, 2023

(51) Int. Cl. B60R 13/02

(52) U.S. Cl. CPC B60R 13/0262; B60R 2013/0293

(57) ABSTRACT

A reflection blocking system for preventing light from reflecting off of reflective surfaces of a center console and a gearshift knob includes a center console positioned in a vehicle and a gearshift handle which is positioned in and extends upwardly from the center console. A console cover is provided which comprises a panel with an aperture extending therethrough for receiving the gearshift handle therethrough such that the panel covers the center console. The panel has an upper surface which is nonreflective and faces away from the center console, and the panel is opaque.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to light shield apparatuses and more particularly pertains to a new light shield apparatus for preventing light from reflecting off of reflective surfaces of a center console and a gearshift knob.

### (2) Description of Related Art Including Information Disclosed Under 37 CFR 1.97 and 1.98

The prior art discloses light shield apparatuses for blocking light in a vehicle, including light shield apparatuses which are positioned to block light directed at a display screen to improve a user's view of the display screen. The prior art also includes a light shield apparatus positioned above an instrument panel to prevent light from being directed into a driver's eyes and another light shield apparatus positionable above a steering wheel to shade a driver from hot sunlight. The prior art fails, however, to address a light shield apparatus which is positionable over a center console or a gearshift handle to prevent light from reflecting off of the center console or gearshift handle and into a driver's eyes.

### BRIEF SUMMARY OF THE INVENTION

An embodiment of the disclosure meets the needs presented above by generally comprising a center console positioned in a vehicle and a gearshift handle which is positioned in and extends upwardly from the center console. A console cover is provided which comprises a panel with an aperture extending therethrough for receiving the gearshift handle therethrough such that the panel covers the center console. The panel has an upper surface which is nonreflective and faces away from the center console, and the panel is opaque.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a console cover and a gearshift cover of a reflection blocking system according to an embodiment of the disclosure.

FIG. 2 is a top view of a console cover of an embodiment of the disclosure.

FIG. 3 is a front view of a gearshift cover of an embodiment of the disclosure.

FIG. 4 is a cross-sectional view of a console cover of an embodiment of the disclosure taken from Arrows 4-4 in FIG. 2.

FIG. 5 is a cross-sectional view of a gearshift cover of an embodiment of the disclosure taken from Arrows 5-5 in FIG. 3.

FIG. 6 is an in-use view of an embodiment of the disclosure.

FIG. 7 is an in-use view of an embodiment of the disclosure.

### DETAILED DESCRIPTION OF THE INVENTION

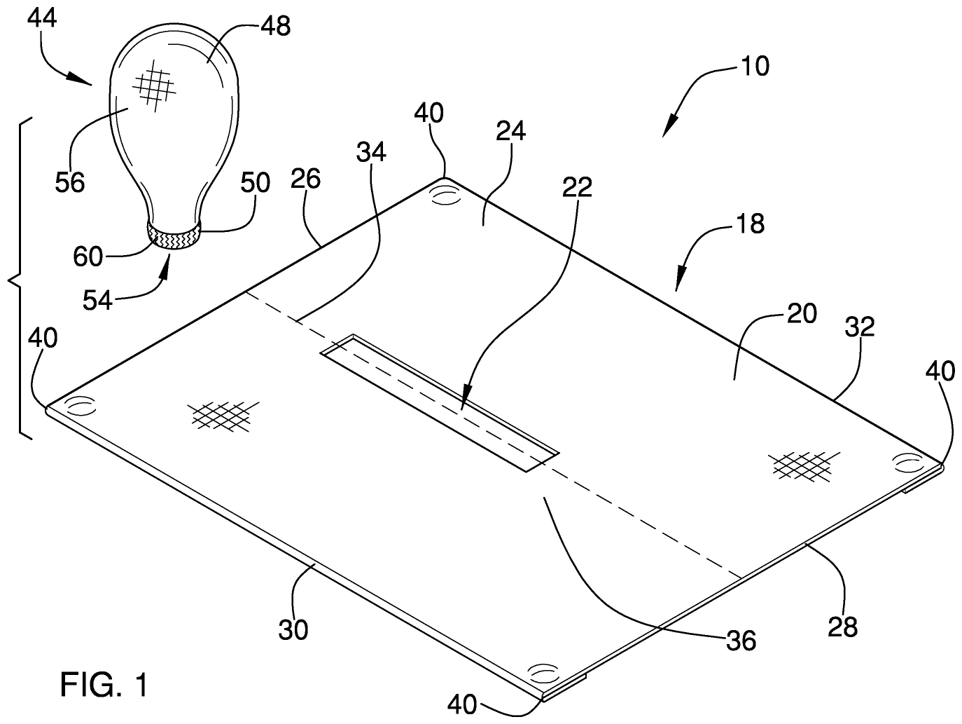

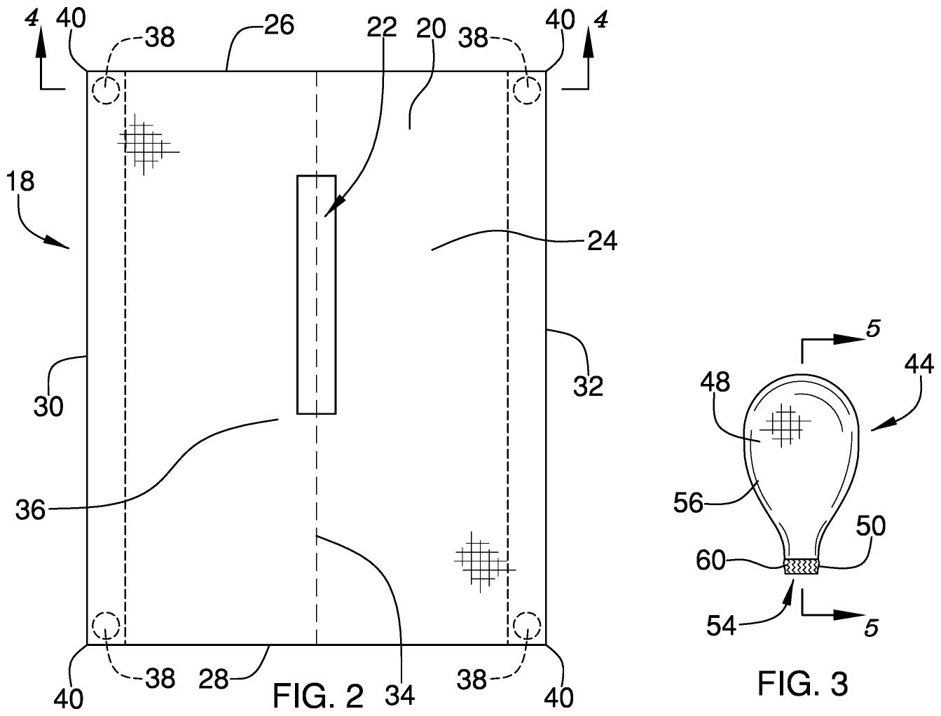

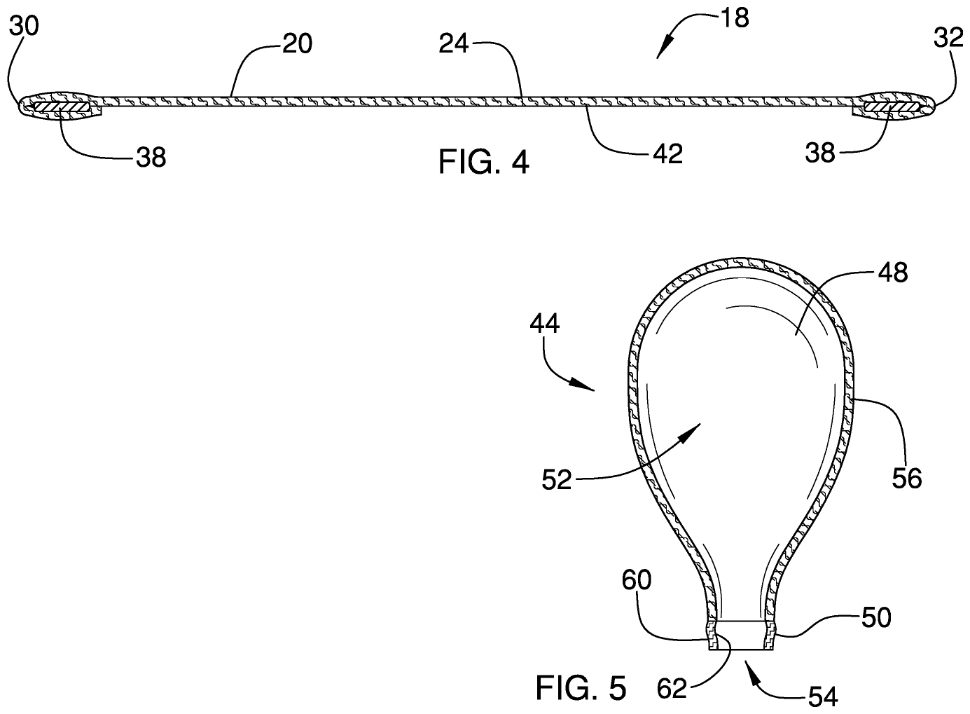

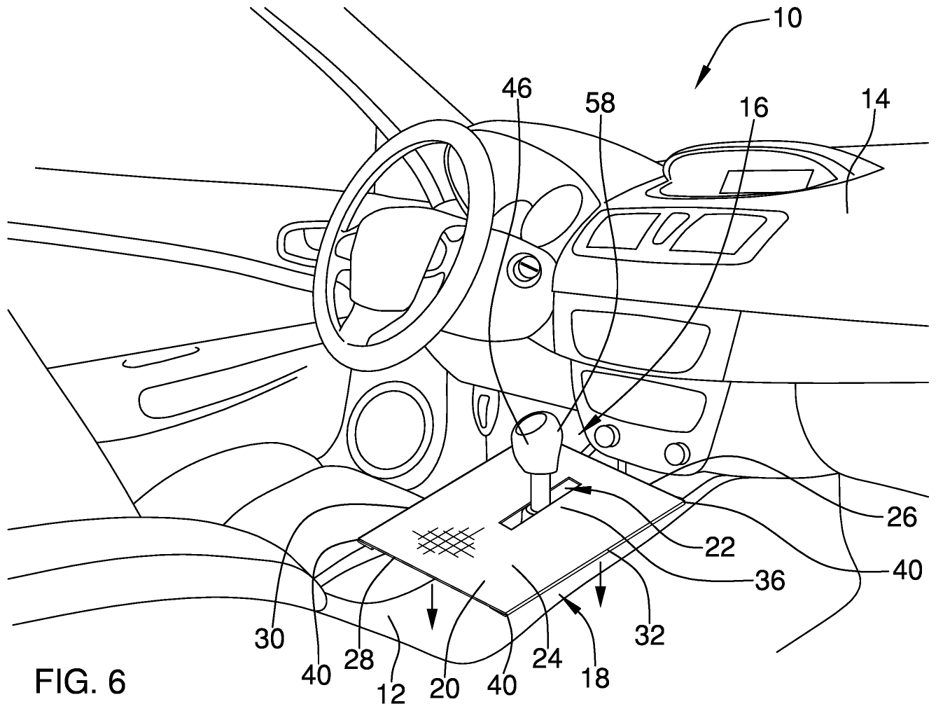

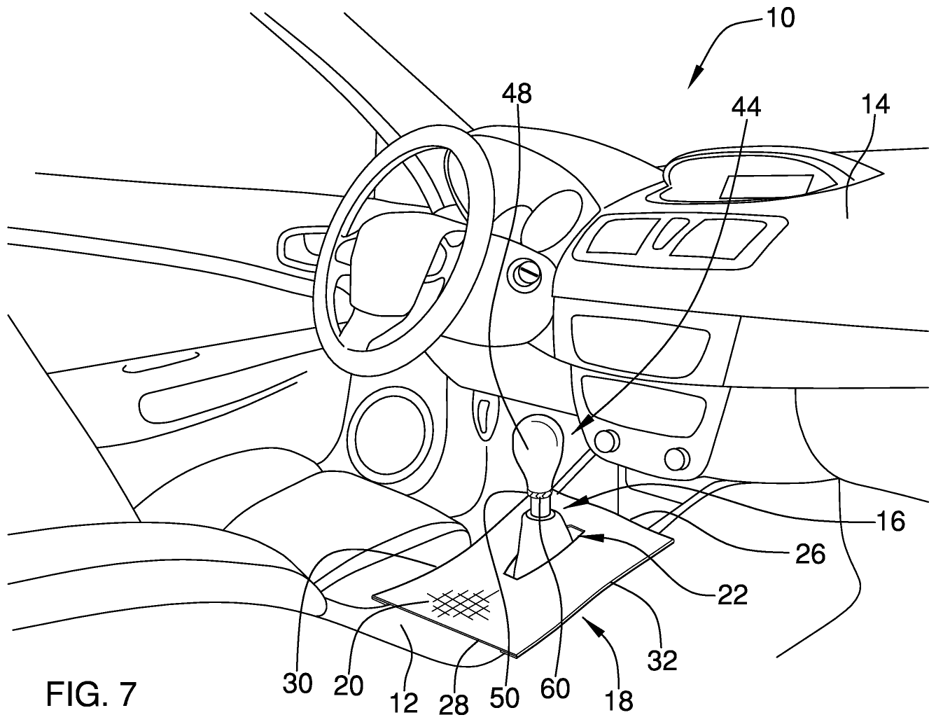

With reference now to the drawings, and in particular to FIGS. 1 through 7 thereof, a new light shield apparatus embodying the principles and concepts of an embodiment of the disclosure and generally designated by the reference numeral 10 will be described.

As best illustrated in FIGS. 1 through 7, the reflection blocking system 10 generally comprises a center console 12 positioned in a vehicle 14 and a gearshift handle 16 positioned in and extending upwardly from the center console 12. A console cover 18 is provided which comprises a panel 20 with an aperture 22 extending therethrough for receiving the gearshift handle 16 therethrough such that the panel 20 covers the center console 12. The panel 20 has an upper surface 24 which is nonreflective and faces away from the center console 12. The panel 20 is also opaque. The panel 20 is flexible such that the panel 20 drapes over the center console 12 when positioned thereon.

The panel 20 has a front end 26, a rear end 28, a first lateral edge 30 and a second lateral edge 32, in which each of the first and second lateral edges 30, 32 extend between the front end 26 and the rear end 28. The aperture 22 is elongated along a line orientated parallel to the first and second lateral edges 30, 32 and is aligned with a central axis 34 of the panel 20 extending through the front end 26 and the rear end 28. The aperture 22 is positioned closer to the front end 26 than the rear end 28. The panel 20 comprises a cloth material.

Each of the first and second lateral edges 30, 32 is weighted relative to a central area 36 of the panel 20 to facilitate retaining the panel 20 in a position on the center console 12. The first and second lateral edges 30, 32 are weighted by a plurality of weights 38 secured to the panel 20 in which the first lateral edge 30 and the second lateral edge 32 each includes at least two weights 38. The panel 20 has four corners 40, and each of the corners 40 has at least one weight 38 positioned adjacent thereto. Each weight 38 is positioned between the upper surface 24 and a lower surface 42 of the panel 20.

A gearshift cover 44 is provided for covering a knob 46 of the gearshift handle 16. The gearshift cover 44 comprises a sleeve 48 and a securing member 50. The sleeve 48 has a receiving space 52 positioned therein and an opening 54 extending therethrough to the receiving space 52. The sleeve 48 is shaped to receive the knob 46 of the gearshift handle 16 through the opening 54 into the receiving space 52. An outer surface 56 of the sleeve 48 is nonreflective, and the sleeve 48 is opaque. The sleeve 48 is also flexible such that the sleeve 48 is positionable to conform to an exterior surface 58 of the knob 46. The securing member 50 is attached to the sleeve 48 to releasably secure the sleeve 48 to the gearshift handle 16. The securing member 50 comprises a strap 60 which is coupled to the sleeve 48 and extends around a perimeter 62 of the opening 54, but the securing member 50 may include a releasable fastener such as a snap button, hook-and-loop fastener, or the like to retain the sleeve 48 to the knob 46. The strap 60 is resiliently stretchable such that the strap 60 contracts around the gearshift handle 16 to retain the sleeve 48 to the knob 46, but the strap 60 may include a buckle, snap button, or other retaining means such that the strap 60 is retainable against the gearshift handle 16. The strap 60 may comprise rubber, elastin, nylon, or the like.

In use, the console cover 18 is positioned over the center console 12 such that the gearshift handle 16 extends through the aperture 22. The console cover 18 blocks light from reflecting off of any surfaces of the center console 12 which are positioned underneath the console cover 18 and into a vehicle 14 occupant's eyes. The aperture 22 allows the gearshift handle 16 to be moved relative to the console cover 18 without shifting the console cover 18 relative to the center console 12. The weights 38 resist shifting of the console cover 18 relative to the center console 12 due to air currents or other perturbations. The gearshift cover 44 is positioned over the knob 46 of the gearshift handle 16 and retained on the knob 46 via the securing member 50. While positioned over the knob 46, the gearshift cover 44 blocks light from reflecting off the knob 46 and into the vehicle 14 occupant's eyes. The console cover 18 and the gearshift cover 44 can be removed when not needed for blocking light.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reflection blocking system for blocking light from reflecting off surfaces in an automobile, the system comprising:
a center console positioned in the vehicle;
a gearshift handle being positioned in and extending upwardly from the center console; and
a console cover comprising a panel having an aperture extending therethrough for receiving the gearshift handle therethrough such that the panel covers the center console, the panel having an upper surface which is nonreflective and faces away from the center console, the panel being opaque.

2. The system of claim 1, wherein the panel is flexible such that the panel is formable into a storage condition.

3. The system of claim 1, wherein the panel has a front end, a rear end, a first lateral edge and a second lateral edge, each of the first and second lateral edges extending between the front end and the rear end, the aperture being elongated along a line orientated parallel to the first and second lateral edges.

4. The system of claim 1, wherein the panel has a front end, a rear end, a first lateral edge and a second lateral edge, each of the first and second lateral edges extending between the front end and the rear end, the aperture being aligned with a central axis of the panel extending through the front end and the rear end.

5. The system of claim 1, wherein the panel has a front end, a rear end, a first lateral edge and a second lateral edge, each of the first and second lateral edges extending between the front end and the rear end, the aperture being positioned closer to the front end than the rear end.

6. The system of claim 1, wherein the panel comprises a cloth material.

7. The system of claim 1, wherein the panel has a front end, a rear end, a first lateral edge and a second lateral edge, each of the first and second lateral edges extending between the front end and the rear end, each of the first and second lateral edges being weighted relative to a central area of the panel to facilitate retaining the panel in a position on the center console.

8. The system of claim 7, wherein the first and second lateral edges are weighted by a plurality of weights secured to the panel, wherein the first lateral edge and the second lateral edge each includes at least two weights.

9. The system of claim 8, wherein the panel has four corners, each of the corners having at least one weight positioned adjacent thereto.

10. The system of claim 8, wherein each weight is positioned between the upper surface and a lower surface of the panel.

11. The system of claim 1, further comprising a gearshift cover comprising a sleeve having a receiving space positioned therein, the sleeve having an opening extending therethrough to the receiving space, the sleeve being shaped to receive a knob of the gearshift handle through the opening into the receiving space, an outer surface of the sleeve being nonreflective, the sleeve being opaque.

12. The system of claim 11, wherein the sleeve is flexible such that the sleeve is positionable to conform to an exterior surface of the knob.

13. The system of claim 11, wherein the gearshift cover further comprises a securing member being attached to the sleeve to releasably secure the sleeve to the gearshift handle.

14. The system of claim 13, wherein the securing member comprises a strap being coupled to the sleeve and extending around a perimeter of the opening.

15. The system of claim 14, wherein the strap is resiliently stretchable.

16. A reflection blocking system for blocking light from reflecting off surfaces in an automobile, the system comprising:
a center console positioned in the vehicle;
a gearshift handle being positioned in and extending upwardly from the center console;
a console cover comprising a panel having an aperture extending therethrough for receiving the gearshift handle therethrough such that the panel covers the center console, the panel having an upper surface which is nonreflective and faces away from the center console, the panel being opaque, the panel being flexible such that the panel is formable into a storage condition, the panel having a front end, a rear end, a first lateral edge and a second lateral edge, each of the first and second lateral edges extending between the front end and the rear end, the aperture being elongated along a line orientated parallel to the first and second lateral edges, the aperture being aligned with a central axis of the panel extending through the front end and the rear end, the aperture being positioned closer to the front end than the rear end, the panel comprising a cloth material, each of the first and second lateral edges being weighted relative to a central area of the panel to facilitate retaining the panel in a position on the center console, the first and second lateral edges being weighted by a plurality of weights secured to the panel, wherein the first lateral edge and the second lateral edge each includes at least two weights, the panel having four corners, each of the corners having at least one weight positioned adjacent thereto, each weight being positioned between the upper surface and a lower surface of the panel; and
a gearshift cover comprising:
a sleeve having a receiving space positioned therein, the sleeve having an opening extending therethrough to the receiving space, the sleeve being shaped to receive a knob of the gearshift handle through the opening into the receiving space, an outer surface of the sleeve being nonreflective, the sleeve being opaque, the sleeve being flexible such that the sleeve is positionable to conform to an exterior surface of the knob; and
a securing member being attached to the sleeve to releasably secure the sleeve to the gearshift handle, the securing member comprising a strap being coupled to the sleeve and extending around a perimeter of the opening, the strap being resiliently stretchable.
